(19) United States
(12) Patent Application Publication
(10) Pub. No.: US 2014/0169872 A1
(43) Pub. Date: Jun. 19, 2014

(54) MOUNTING DEVICE FOR EXPANSION CARD

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: KANG WU, Shenzhen (CN); BO TIAN, Shenzhen (CN); YU HAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/727,562

(22) Filed: Dec. 26, 2012

(30) Foreign Application Priority Data
Dec. 19, 2012 (CN) 201210554300.5

(51) Int. Cl. H01R 13/627

(52) U.S. Cl. CPC H01R 13/627
USPC 403/376

(57) ABSTRACT

A mounting device for expansion card includes a main body and a holding member. The holding member includes a fixing member mounted to the main body, and a pivoting member pivotably mounted to the fixing member. The pivoting member defines a slot to receive an end of an expansion card.

### BACKGROUND

1. Technical Field

The present disclosure relates to a mounting device for expansion card.

2. Description of Related Art

In installing an expansion card, one end of the expansion card is generally fixed to a chassis, while an opposite end of the expansion cards is cantilevered. As a result, when an expansion card is long and horizontally fixed to the chassis, the cantilevered end may droop and cause damage to the expansion card.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a mounting device including a holding member, together with an expansion card.

FIG. 2 is similar to FIG. 1, but viewed from another perspective.

FIG. 3 is an enlarged view of the holding member of FIG. 1.

FIG. 4 is a partially assembled view of FIG. 1.

FIG. 5 is an enlarged view of the circled portion IV of FIG. 4.

FIG. 6 is an assembled, isometric view of FIG. 1.

FIG. 7 is similar to FIG. 6, but viewed from another perspective.

FIG. 8 is an enlarged view of the circled portion VIII of FIG. 7.

FIG. 9 is similar to FIG. 4, but showing another using state.

FIG. 10 is an enlarged view of the circled portion X of FIG. 9.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

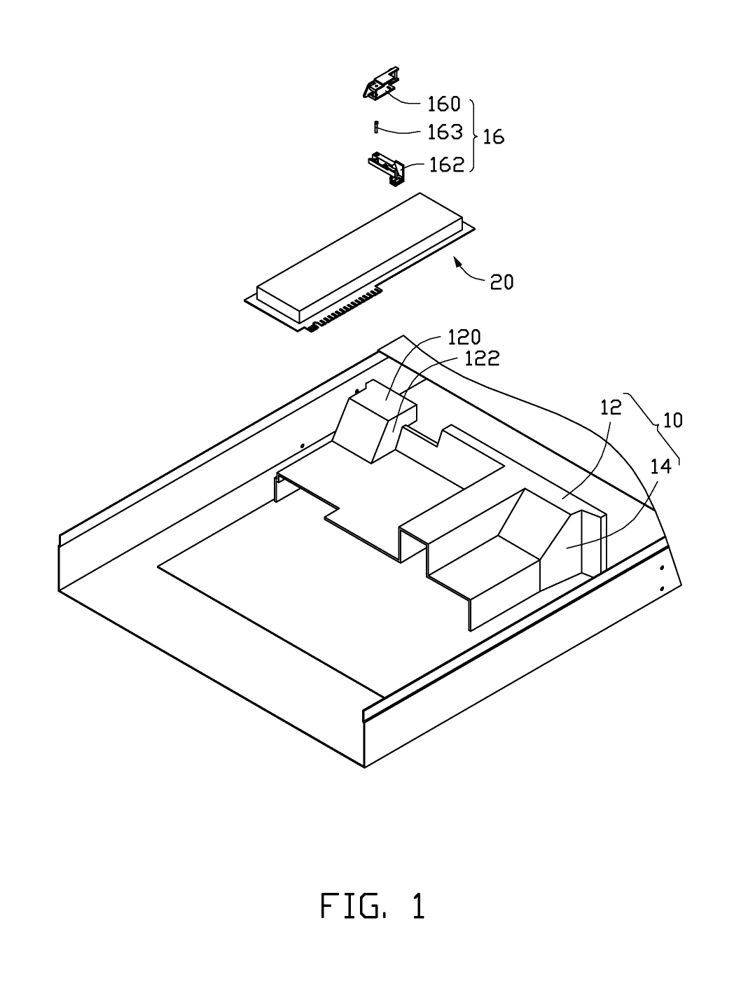

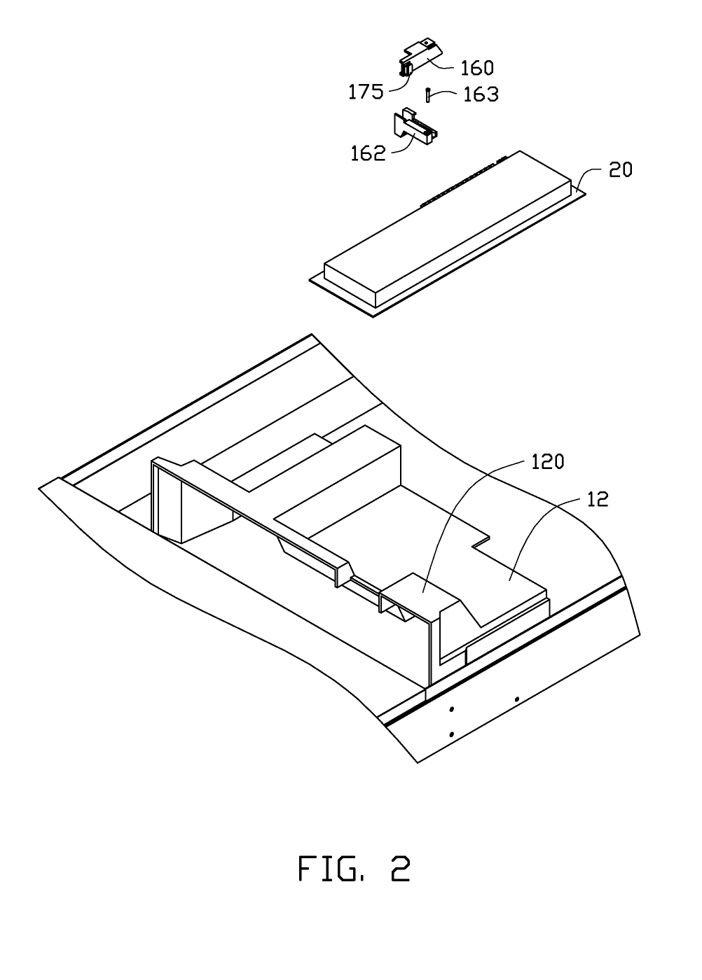

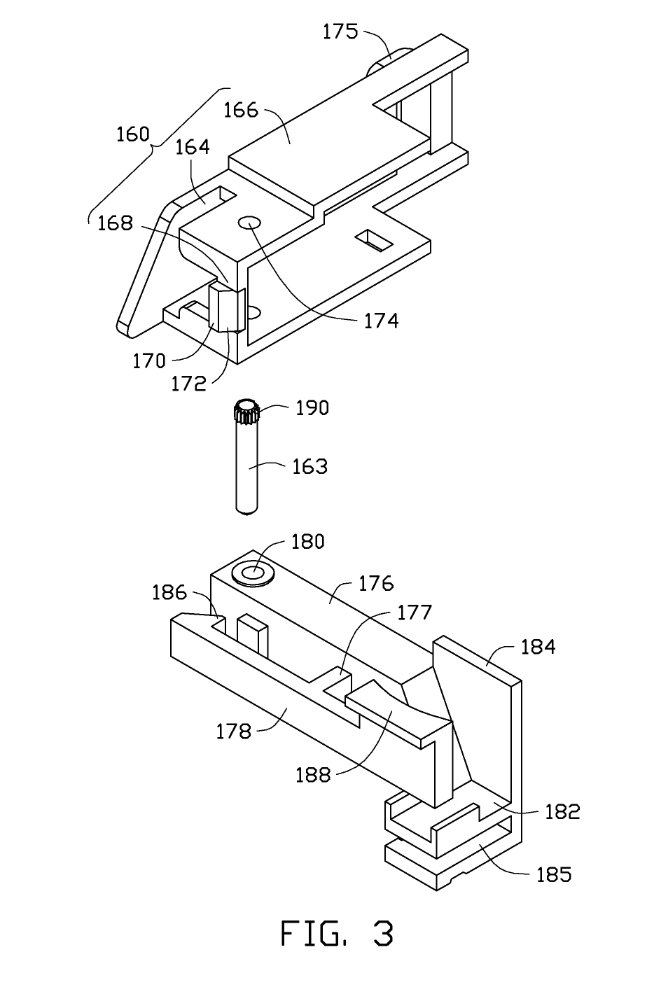

FIGS. 1 to 3 show an exemplary embodiment of a mounting device for holding a cantilevered end of an expansion card 20.

The mounting device includes a main body 10 including a top board 12, two side boards 14 perpendicularly extending down from opposite ends of the top board 12, and a holding member 16. A hollow protrusion 120 protrudes from the top board 12 adjacent to a front side of the top board 12. The protrusion 120 includes a sidewall 122 parallel to the side boards 14. In this embodiment, the main body 10 is an air duct.

The holding member 16 includes a fixing member 160, a pivoting member 162, and a post 163.

The fixing member 160 includes a fixing piece 164 and two extension pieces 166 extending out from a top and a bottom sides of the fixing piece 164, and a bar 168 connected between rear ends of the two extension pieces 166. A block 170 protrudes from an outer surface of the bar 168, and includes a guiding surface 172 opposite to the fixing piece 164 and slantingly extending forward from a side of the block 140 opposite to the bar 168. The extension pieces 166 each define a through hole 174 in front of the bar 168. An L-shaped hook 175 is connected to a front end of a side of the fixing piece 164 opposite to the extension pieces 166.

The pivoting member 162 includes a first plate 176, a second plate 178 parallel to the first plate 176, and a connecting portion 177 connected between the first and second plates 176 and 178. The first plate 176 defines a fixing hole 180 extending through first ends of a top and a bottom side of the first plate 176. Two tabs 182 perpendicularly extend rearward from a second end of the first plate 176 opposite to the first end. An engaging piece 184 extends up from the second end of the first plate 176. A slot 185 lengthwise along the first plate 176 is defined between the tabs 182. A projection 186 protrudes from a first end of an inner surface of the second plate 178 facing the first plate 176 and adjacent to the fixing hole 180. An operation portion 188 extends up and then bends rearward from a second end of the second plate 178 adjacent to the engaging piece 184. A surface of the operation portion 188 facing the first plate 176 is curved.

An anti-skid portion 190 is formed on a top end of a circumference of the post 163.

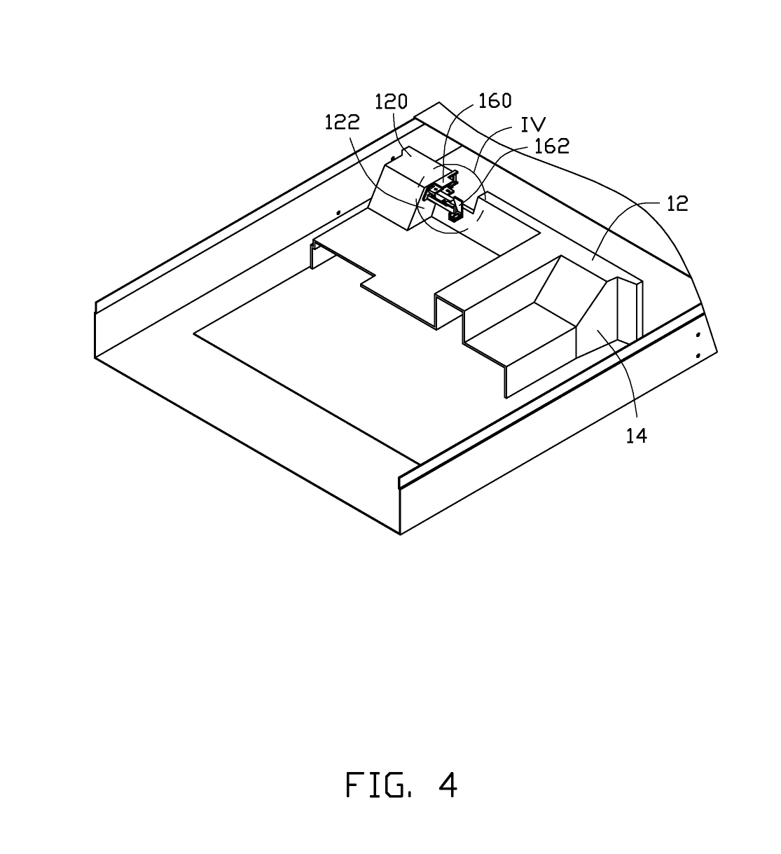

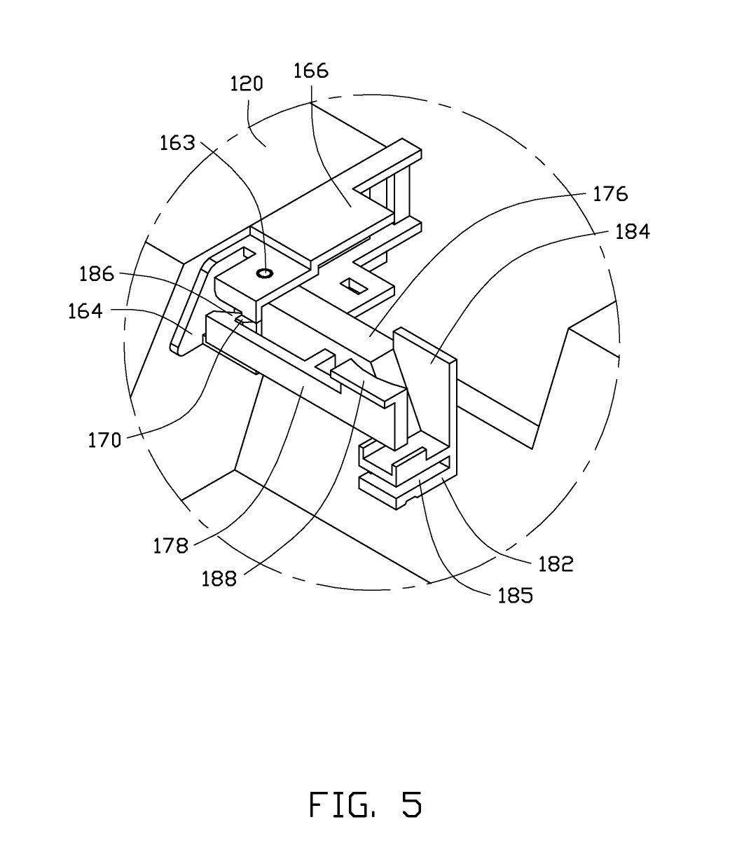

FIGS. 4 and 5 show that, in assembly, the hook 175 is engaged with a front end of the sidewall 122, to fix the fixing member 160 to an outer surface of the sidewall 122. The first end of the first plate 176 is received between the extension pieces 166. The post 163 extends through the upper through hole 174, the fixing hole 180 and the lower through hole 174, until the anti-skid portion 190 engages with an inner surface of the upper through hole 174, thereby pivotably mounting the pivoting member 162 to the fixing member 160.

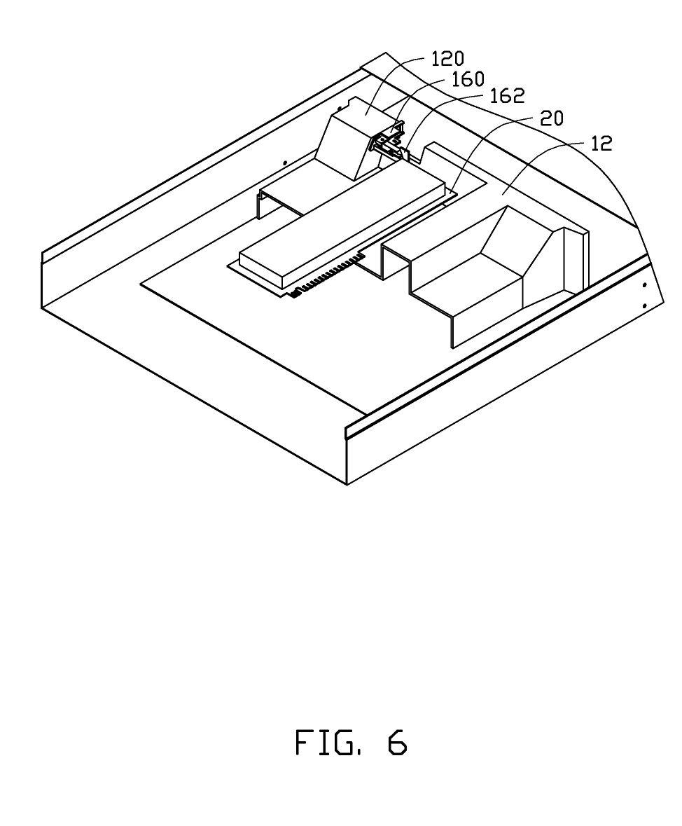

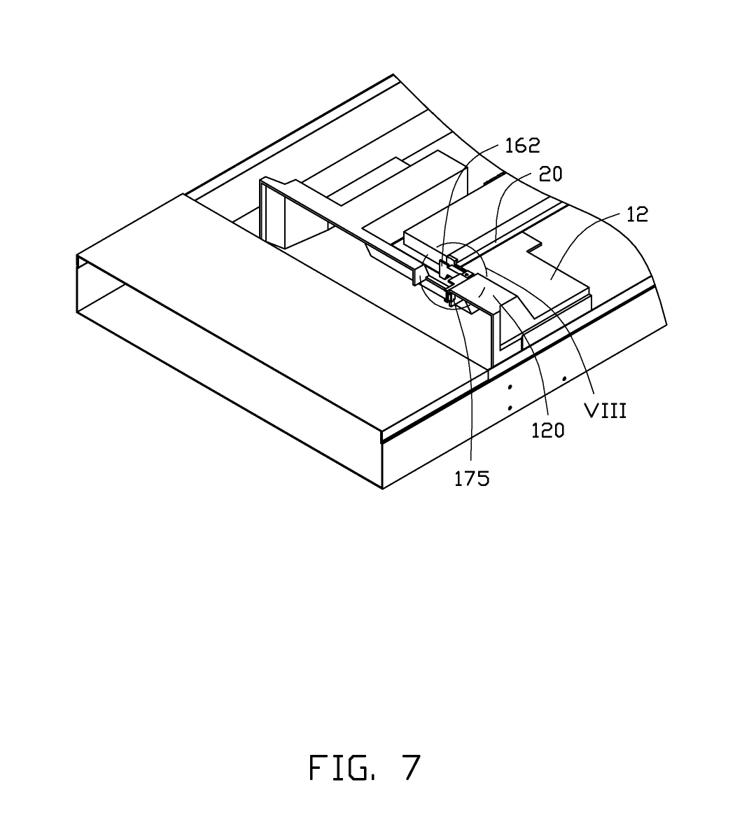

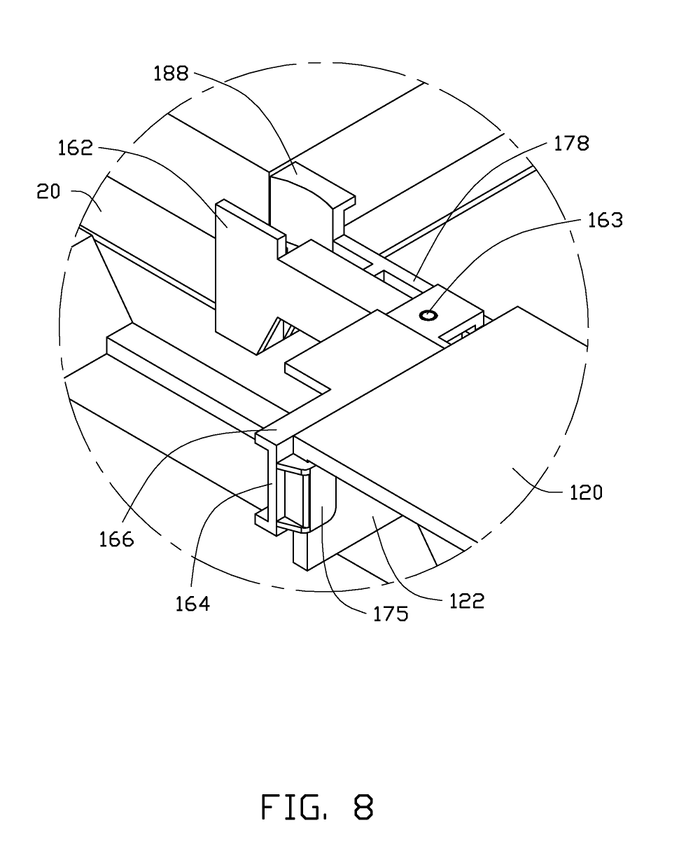

Referring to FIGS. 6 to 8, in holding the cantilevered end of the expansion card 20, the operation portion 188 is operated to pivot the pivoting member 162 rearward toward the expansion card 20, until the projection 186 slides along the guiding surface 172 and is then blocked by a surface of the block 170 facing the fixing piece 164, thereby, the pivoting member 162 becomes immovable and perpendicular to the fixing member 160. The cantilevered end of the expansion card 20 is engaged in the slot 185.

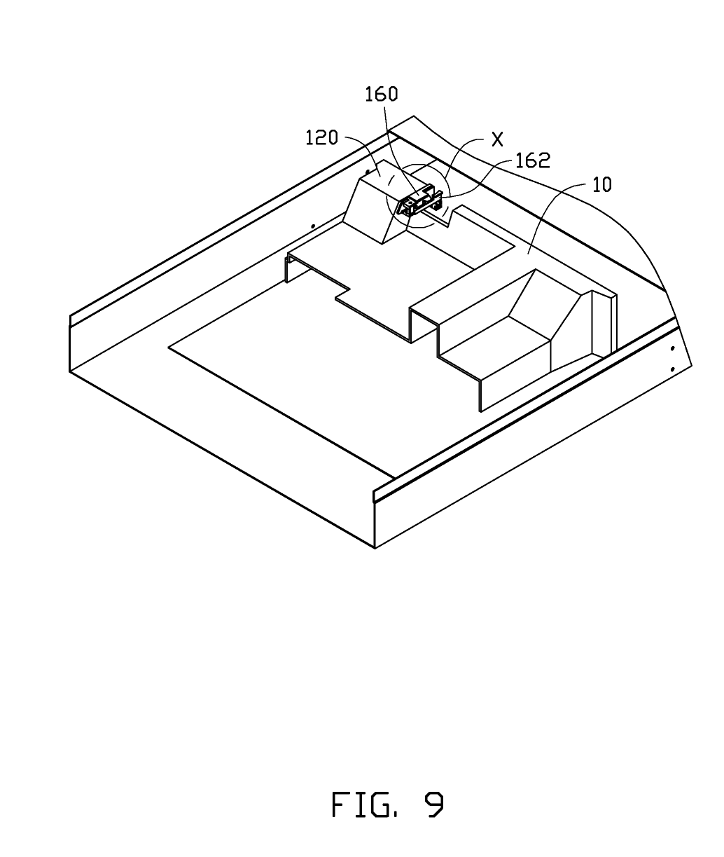

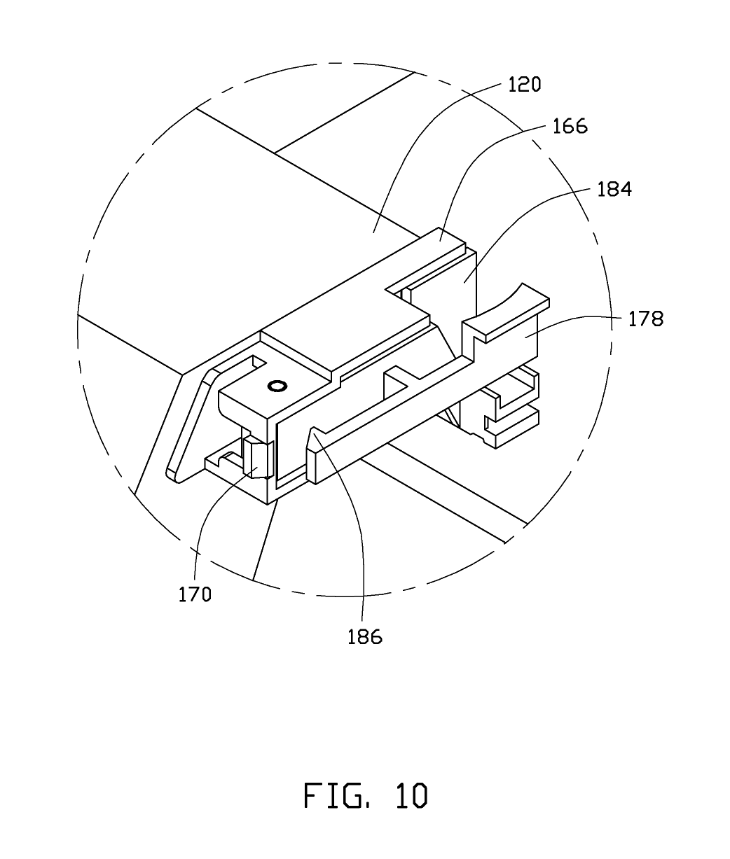

Referring to FIGS. 9 and 10, in disengaging the expansion card 20, the operation portion 188 is pushed toward the first plate 176 to deform the second plate 178, thereby disengaging the projection 186 from the block 170. The pivoting member 162 is then pivoted forward away from the expansion card 20 until the engaging piece 184 abuts an inner surface of the upper extension piece 166.

In another embodiment, the engaging piece 184 may extend down from the first plate 176 and engage with an inner surface of the lower extension piece 166.

In another embodiment, one of the extension pieces 166 may define a cutout in the inner surface; the first plate 176 may form a projection to engage in the cutout, by these means, the pivoting member 162 becomes immovable and parallel to the fixing member 160.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device, comprising:
a main body; and
a holding member comprising a fixing member mounted to the main body and a pivoting member pivotably mounted to the fixing member, the pivoting member defining a slot to receive an end of an expansion card.

2. The mounting device of claim 1, wherein the fixing member comprise a fixing piece mounted to the main body and two extension pieces extending out from opposite sides of the fixing piece, the pivoting member comprises a first plate, and a post extending through the extension pieces and the first plate to pivotally mount the first plate between the extension pieces, the slot is defined in the first plate.

3. The mounting device of claim 2, wherein an engaging piece extends from the first plate to engage with an inner surface of one of the extension pieces.

4. The mounting device of claim 2, wherein a bar is connected between the extension pieces, a block protrudes from a side of the bar, the pivoting member comprises a second plate connected to a side of the first plate opposite to the fixing piece, a projection protrudes from the second plate to engage with the block, thereby the pivoting member is unmovable.

5. The mounting device of claim 4, wherein the first and second plates are positioned at opposite sides of the bar.

6. The mounting device of claim 2, wherein a protrusion protrudes from the main body and comprises a sidewall, an L-shaped hook is connected to a side of the fixing piece opposite to the extension pieces to engage with the sidewall, to fix the fixing member to the sidewall.

7. The mounting device of claim 6, wherein the main body is an air duct comprising a top board and two side boards extending down from opposite sides of the top board, the protrusion protrudes from the top board.
